(19) United States
(12) Patent Application Publication
(10) Pub. No.: US 2013/0262299 A1
(43) Pub. Date: Oct. 3, 2013

(54) ELECTRONIC PAYMENT DEVICE ABLE TO RECEIVE AND HOLD A PORTABLE TELEPHONE

(71) Applicants: Pierre Lacroix, Saint-Peray (FR); Fabrice Fleury, Saint-Peray (FR); Sylvain Barneron, Valence (FR); Olivier Yernaux, Laudun L'Ardoise (FR); Eric Bonnet, Malissard (FR); Didier Georges, Chabeuil (FR)

(72) Inventors: Pierre Lacroix, Saint-Peray (FR); Fabrice Fleury, Saint-Peray (FR); Sylvain Barneron, Valence (FR); Olivier Yernaux, Laudun L'Ardoise (FR); Eric Bonnet, Malissard (FR); Didier Georges, Chabeuil (FR)

(73) Assignee: Compagnie Industrielle et Financiere D'Ingenierie "Ingenico", Paris (FR)

(21) Appl. No.: 13/992,592

(22) PCT Filed: Dec. 7, 2011
(86) PCT No.: PCT/EP2011/072007

§ 371 Date: Jun. 7, 2013

(30) Foreign Application Priority Data
Dec. 7, 2010 (FR) 1060204

(51) Int. Cl. G06Q 20/32

(52) U.S. Cl. CPC G06Q 20/322
USPC 705/39

(57) ABSTRACT

An electronic payment device is provided, which includes a chip card reader. The device has a housing able to receive and hold a portable telephone, a connector for connection with the portable telephone, and a data processor able to receive information relating to a payment and to exchange data with a remote server via a telephone communication implemented by said portable telephone.

### CROSS-REFERENCE TO RELATED APPLICATIONS

This Application is a Section 371 National Stage Application of International Application No. PCT/EP2011/072007, filed Dec. 7, 2011, which is incorporated by reference in its entirety and published as WO 2012/076573 on Jun. 14, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE INVENTION

The invention pertains to electronic payment by means of bank cards, and especially smartcards and/or magnetic cards, in nomadic applications.

### PRIOR ART

It is a classic practice to make payment in business establishments by means of bank cards. The payment device is generally connected by telephone to a bank server to verify that the transaction can be made (for example by checking the customer's creditworthiness) and to record this transaction.

In certain cases, the payment device can be detached from its cradle which is itself linked by telephone to the bank server or servers. A wireless link, for example a WiFi link, is set up between the device and its cradle. This enables the device to be shifted in proximity to the cradle (to several tens of meters) for example in a restaurant. However, a wired telephone connection remains necessary and this technique is not suited to many nomadic situations (for example for taxi drivers, fairground tradesmen, doctors, home-care services, etc).

It was then envisaged to equip payment terminals with wireless telephone means capable of exchanging data, for example according to the GPRS standard. This approach is technically worthwhile but implies the use of specific telephony means in the payment device with a dedicated SIM card and a specific and costly subscription (whereas the quantity of data exchanged is very small).

It has also been envisaged in certain portable telephones to have a bank card reader. However, this approach is impractical, and leads to a major increase in the volume, weight, cost and consumption of the telephone which is not compatible with the users' expectations and requirements. An embodiment of the present disclosure relates to an electronic payment device comprising a smartcard reader comprising a housing capable of receiving and holding a portable telephone and means of connection with said portable telephone and means for processing data capable of receiving information pertaining to a payment and of exchanging data with a remote server, via a telephone communication implemented by said portable telephone.

Thus, according to the invention, an autonomous and nomadic payment device is available, capable of being used in any place (in a taxi, at a person's home, etc) provided that it is possible to have a telephone communication via the cell network.

However, it is not necessary for the device to have its own communications means available, and especially its own SIM card and a corresponding subscription since it is planned to make use of a classic portable telephone which the user can moreover use for voice communications or any other application.

According to one particular aspect of at least one embodiment of the invention, said means for processing secure a transaction in taking account of at least one first piece of information contained in said electronic payment device and of at least one second piece of information contained in said portable telephone.

In general, indeed, it is desirable that the device of the invention should maximize the security of the transmission of the transaction in combating any fraudulent use. Here, this approach makes it possible for example to avoid the use of an unauthorized telephone (or an unauthorized SIM card).

According to certain embodiments, the payment device also comprises means for reading a magnetic track of a magnetic card.

It is indeed desirable to be able to use the magnetic cards, in certain cases and/or in certain countries, as a complement to the chip or as a replacement for it.

In this case, especially because of the desirable compactness of the device, in certain embodiments, a slot is provided for introducing a magnetic card that extends longitudinally, on one side of its case.

This approach enables discreet and compact integration.

In one particular embodiment, the means for reading the magnetic track comprise a magnetic reading head mounted on an element made of elastomer or a similar material, possessing a modulus of elasticity greater than 200 N/mm².

It is indeed desirable that the reading head should have a certain degree of controlled mobility during the shifting of the payment card before this head. This is all the more important when the device is small-sized and intended for nomadic applications.

According to another particular aspect, the device of the invention comprises protection elements placed in the vicinity of said slot so as to prevent a fraudulent insertion of a second reading head and/or electronic access to internal elements.

These protection elements are useful especially because of the position of the slot along the case, which opens out an aperture towards the interior of the device (whereas, generally, the magnetic reading means are in the upper part of the case and can be physically isolated).

According to one particular embodiment of the invention, said housing has two lateral walls, enabling said portable telephone to be inserted by sliding.

It is thus possible to fixedly attach the two elements together in an efficient manner.

Besides, the payment device can comprises mechanical means for blocking said portable telephone in said housing when it is in its position of use.

This makes it possible to secure the telephone (for example in the event of a fall) and/or ensure that the telephone is truly in position for the entire transaction.

According to yet another particular aspect of certain embodiments, the payment device can comprise means for optimizing the electrical charging of a battery and/or its electrical consumption in taking account of the charge of the battery of said portable telephone.

It is this possible to optimize the management of the power supplies and to make transactions even if one of the elements, taken independently, is insufficiently charged.

According to yet another particular aspect of certain embodiments, the payment device can also comprise means of connection to means for charging a battery, placed in a housing also designed to receive a smartcard.

Thus, it is not necessary to provide a specific port to supply power to the device and the possible problems due to the static electricity are limited especially by using an adapted charging cradle (i.e. one comprising a male part with a format that coincides substantially and partially with that of a smartcard).

### LIST OF FIGURES

Other features and advantages of the invention shall appear more clearly from the following description of a preferred embodiment of the invention given by way of a simple illustratory and non-exhaustive example and from the appended figures, of which:

FIGS. 1A and 1B illustrate an example of a payment device according to the invention, respectively seen from the top and from the bottom;

FIGS. 2A and 2B illustrate the fixed joining of a portable telephone to the device of FIGS. 1A and 1B.

### DESCRIPTION OF ONE EMBODIMENT OF THE INVENTION

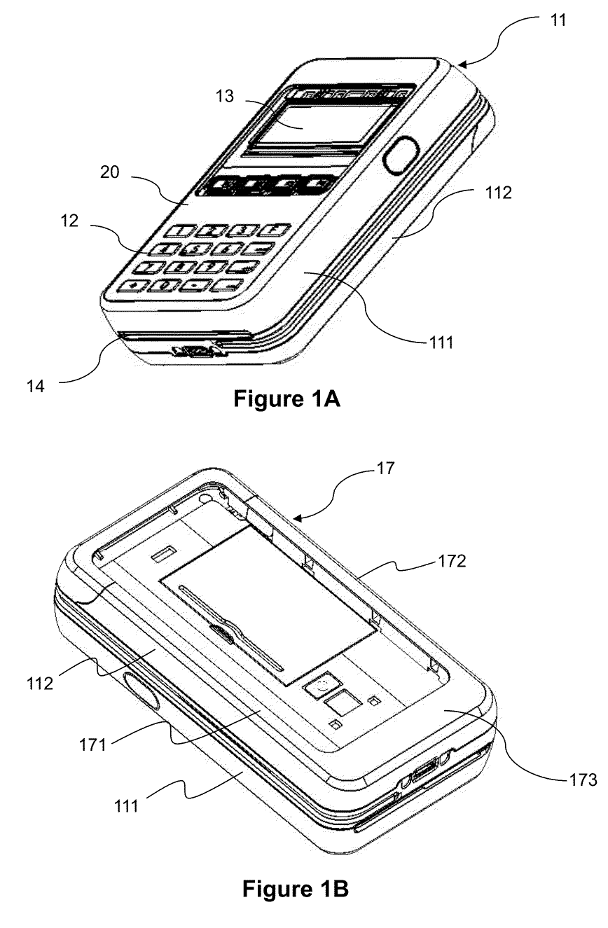

As indicated here above, the invention therefore pertains to a nomadic payment device. An example of such a payment device is illustrated in FIGS. 1A and 1B.

This payment device has a case 11 made for example out of plastic in the form of two half-shells 111 and 112, for example fixedly attached together by being clipped together. On its upper face (the notions of upper face and lower face are herein chosen arbitrarily for purposes of explanation), it is possible to distinguish the elements of the man-machine interface enabling a transaction to be made, namely a keypad 12 and a screen 13. In other embodiments, the screen can be touch-sensitive screen and the keypad can be eliminated. In another variant, the keypad and the screen could also be eliminated, with the payment device then using the man-machine interface of the portable telephone that is adjoined to it as explained here below. However, it can be useful to preserve these elements which enable a local use of the payment device when there is no portable telephone, for example to verify or edit a day's transactions.

A printer (not seen) is provided to deliver especially receipts through an output provided for this purpose, at the upper part of the case.

The payment device comprises, within the case, the different electronic means used to manage a transaction (controlling the man-machine interface, checking a bank code, encoding and encrypting data, communications, etc).

A smartcard can be inserted into the case 11 via the slot 14 provided for this purpose in the lower part of the case. This slot 14 communicates with reading means of the smartcard.

According to one particular aspect, this slot may also be used for the electrical charging of the battery of the payment device. This approach optimizes the different interface elements needed (in the context of the case having a small volume). At the same time, it limits the problems due to static electricity since the electrical connections are made inside the case.

A second slot 15 is planned longitudinally, i.e. on the length of the case, to provide for the reading of the magnetic track cards (in simplified embodiments, it is possible not to have such magnetic card readers).

A magnetic card reader (not seen) is provided to read the contents of the track of a card which will be shifted in translation inside this slot 15. To ensure accurate reading, while the magnetic card can be shifted at greater or lesser speeds and in a plane which is not quite parallel to the case (the right alignment of the magnetic card being all the more difficult as the payment device is portable and therefore hand-held and small-sized), the magnetic head is mounted on a flexible element, for example made out of elastomer. This permits a slight shifting of the head perpendicularly to the magnetic card and/or in a pivoting motion.

In order to prevent the fraudulent insertion of a second magnetic head or of means used to read electronic signals, there are advantageously provided means (not seen) extending in proximity to the slot, on the side of the reading head. These means, which hinder the fraudulent insertion of objects, can be for example be a first printed circuit (daughterboard) connected to a second printed circuit (motherboard) carrying one or more components dedicated to the security or to exchanges with the portable telephone. This first printed circuit can also be equipped with conductive elements, for example in the form of a lattice.

Such a device, in one particular embodiment, can also comprise means of contactless communication to communicate with contactless payment cards. Thus, the device can also be used to handle smartcards, magnetic track cards and contactless cards as needed.

Besides, a device of the invention can be equipped with means for reading bar codes or a similar code that can be carried on articles. Thus, it possible, by means of the device, to read and identify an article, determine its price (by means of a database stored locally and/or by a connection to a server provided through the telephone), group together several articles if necessary, process the corresponding payment and edit a receipt or an invoice.

As can be seen in FIG. 1B, the lower half-shell 112 defines a housing 17 capable of receiving a portable telephone. In this embodiment, the housing has two lateral slideways 171 and 172 and one back wall 173.

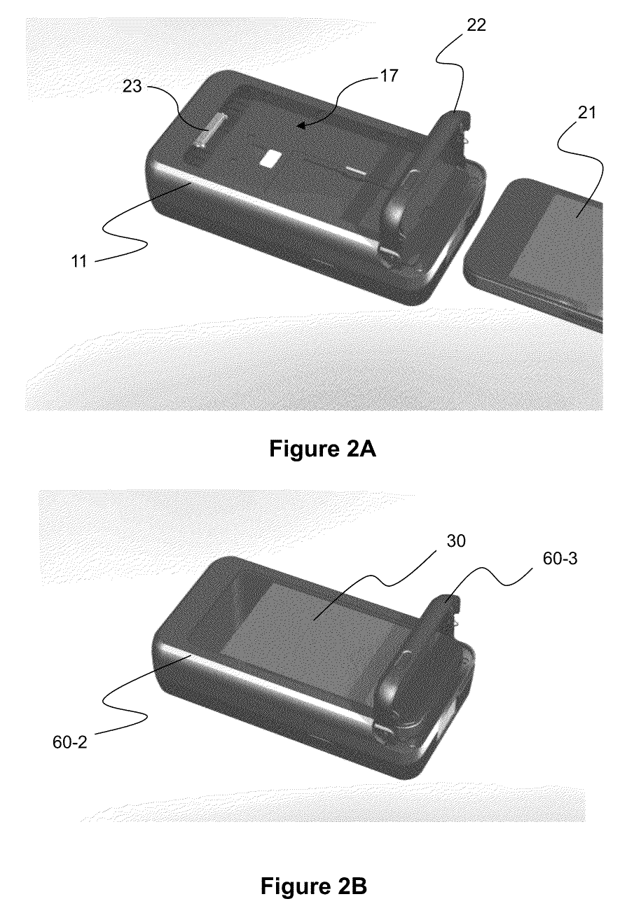

The portable telephone 21 (see FIGS. 2A and 2B) can therefore be inserted, by sliding along the two side walls 171 and 172, into this housing until it comes into contact, in its working position, with the back wall and, more specifically, with a connector 18, provided for this purpose along the back wall 173.

In the embodiment illustrated, the portable telephone 21 is an iPhone 4 (registered mark) by Apple (registered mark). Naturally, the invention can be implemented with other models of telephones (the reception housing and or the connection system being adapted). Such a telephone has a standard female connector capable of cooperating with the male connector 23.

According to one particular embodiment, the payment device can be adapted to be capable of cooperating with several types of portable telephones. To this end, the lateral walls can be interchangeable to match different sizes of portable telephones or receive internal elements enabling their dimensions to be varied or again be configured to guide different forms of telephones, for example by means of flexible leaf springs. Similarly, it is possible to provide for the connector 18 to be interchangeable.

In another approach, the control device of the invention can be equipped with short-distance wireless communication means, for example according to the Bluetooth or ZigBee standard. This removes the need to change the connector.

Such short-distance wireless communications means can also be used to communicate with other nearby apparatuses such as a printer (carried for example on a user's belt), a computer, etc.

As presented in FIGS. 2A and 2B, the housing also has a mobile hood 22 which tilts to enable the insertion and sliding of a portable telephone 21 (FIG. 2B) and can then be folded down to close the housing in a secured manner. Thus, even in the event of an impact, a sudden motion or a fall, there is no risk that the portable telephone 21 will get detached from the device. The housing ensures protection against impact on the part of the portable telephone.

A detachable hood can furthermore be provided to close the housing when there is no portable telephone.

When a telephone is inserted into the housing, the payment device can make use of its communications capacities to communicate with the bank server. Thus, in a simple and economical way, the payment device is given the possibility of communicating by telephone without any dedicated means or subscription.

When the payment device detects the presence of the telephone (for example via the connector 23) it therefore goes into a mode known as transaction mode in which it is capable of making transactions. When no such telephone is present, it is in local or down-graded mode.

In the transaction mode, the payment device can take control over the telephone, for example by activating an application pre-recorded in the portable telephone. As a security measure, this application can for example prevent the launching of another application on the phone (especially assuming that the phone is capable of working in multi-application mode), block the man-machine interface (for example turn off the screen, prevent the entry of data and/or display a message indicating that the telephone is in “transaction mode”, prevent the storage of data in a memory of the telephone, etc.

It can also be possible in certain embodiments to make transactions through a local network, for example of a WiFi type, when such a network is available.

The payment device can also give the telephone the information needed to get connected with the bank server and then get identified with it and finally make the transaction.

According to another aspect, the payment device can also take the charge available in the battery into account so as not to start a transaction if the charge is insufficient. Besides, according to one embodiment of the invention, the payment device comprises means to control and make use of the battery of the telephone to optimize the use of both batteries and to use either one of them for the respective operation of the device and the telephone.

In order to increase the security of the operation, it is also possible for the procedure to comprise an exchange of confidential data between the telephone and the payment device (for example the payment device can verify an identification number stored in the telephone or request the user to key in his confidential pin code before making the transaction). An encryption protocol can also be applied, taking account of information present firstly in the payment device and secondly in the telephone.

Different aspects of such a device mentioned here above and/or complementary aspects are described in greater detail in patent applications filed jointly.

An embodiment of the present disclosure provides a technique to make nomadic payments in a secured way by means of payment cards, for example for taxi drivers, fairground tradesmen, doctors, people providing home-care services, etc.

An embodiment a technique of this kind that is ergonomical and economical.

Although the present disclosure has been described with reference to one or more examples, workers skilled in the art will recognize that changes may be made in form and detail without departing from the scope of the disclosure and/or the appended claims.

1. An electronic payment device comprising:
a smartcard reader;
a housing configured to receive and hold a portable telephone;
a connector configured to make a connection with said portable telephone; and
a data processor configured to receive pieces of information pertaining to a payment and exchange data with a remote server, via a telephone communication implemented by said portable telephone.

2. The electronic payment device according to claim 1, wherein said data processor is configured to secure a transaction by taking account of at least one first piece of information contained in said electronic payment device and of at least one second piece of information contained in said portable telephone.

3. The electronic payment device according to claim 1, further comprising a magnetic card reader configured to read a magnetic track of a magnetic card.

4. The electronic payment device according to claim 3, wherein the device has a slot for introducing a magnetic card that extends longitudinally, on one side of its case.

5. The electronic payment device according to claim 3, wherein the device comprises a magnetic reading head mounted on an element made of elastomer or a similar material, possessing a modulus of elasticity greater than 200 N/mm².

6. The electronic payment device according to claim 4, wherein the device comprises protection elements placed in a vicinity of said slot so as to prevent a fraudulent insertion of a second reading head and/or an electronic access to internal elements.

7. The electronic payment device according to claim 1, wherein said housing has two lateral walls, enabling said portable telephone to be inserted by sliding.

8. The electronic payment device according to claim 7, wherein the device comprises mechanical means for blocking said portable telephone in said housing when said portable telephone is in its position of use in the device.

9. The electronic payment device according to claim 1, wherein the device comprises means for optimizing at least one of the electrical charging of a battery or its electrical consumption in taking account of a charge of the battery of said portable telephone.

10. The electronic payment device according to claim 1, wherein the device comprises a connection to a battery charger, placed in a housing also designed to receive a smartcard.
